(19) United States
(12) Patent Application Publication
(10) Pub. No.: US 2021/0035227 A1
(43) Pub. Date: Feb. 4, 2021

(54) Method of Preparing and Submitting an Insurance Claim

(71) Applicant: Mark J. Pfister, Covington, LA (US)

(72) Inventor: Mark J. Pfister, Covington, LA (US)

(21) Appl. No.: 16/944,360

(22) Filed: Jul. 31, 2020

Related U.S. Application Data
(60) Provisional application No. 62/881,417, filed on Aug. 1, 2019.

(51) Int. Cl. G06Q 40/08

(52) U.S. Cl. CPC G06Q 40/08

(57) ABSTRACT

Methods and devices for submitting data to a system for simplified, verifiable compilation of photographs and related data of lost items to be claimed through an insurance company. One method may include the process performed by a claimant to make a claim for a lost item. The claimant uploads at least one photograph for the claimed item in an account for the claim. The claimant further inputs descriptive data corresponding to the one or more photographs. The descriptive data and one or more photographs are then processed and sent to an independent insurance adjuster.

### RELATED APPLICATIONS

This claims priority to U.S. Provisional Application No. 62/881,417, filed Aug. 1, 2019, the disclosure of which is incorporated herein by reference in its entirety.

### BACKGROUND

Consumer applications and websites are often confusing to individuals who are not technologically savvy. Owning multiple devices is not always feasible. Understanding how to use every platform is also not always within a consumer's abilities. Most consumers have at least one electronic device, such as a desktop, laptop, smart phone, tablet, etc. With various operating systems on each device, a single application for only one type of device or one platform is inconvenient and unusable for many individuals.

Most individuals who own or lease property are required to have insurance. When the insured needs to have damage assessed, waiting for a claims adjuster to physically come to the insured's property and determine damages is time-consuming and draws out the process of making the insured whole again. The ability to digitize the process so that information is processed as efficiently as possible is desirable. However, sometimes, various electronic devices and services (cell towers, power lines, land lines, etc.) are also damaged, leaving the insured with options that may not be simplest to provide data.

Likewise, ensuring that the insured is able to provide all the necessary data to a claims adjuster in a format that can be compatible with various claims adjuster software and insurance software is also desirable.

### SUMMARY

Embodiments of the present disclosure are directed to providing various methods of submitting data to a system for simplified, verifiable compilation of photographs and related data of lost items to be claimed through an insurance company without putting undue burden on the claimant during a stressful time in claimant's life.

One aspect is directed to a method of capturing a contents list for an insurance company. The method comprises: receiving a link from an independent insurance adjuster to a claims application and/or website; uploading at least one photograph for at least one claimed item in an account for the claims application and/or website; providing descriptive data corresponding to the at least one photograph; and submitting the descriptive data and the at least one photograph to the independent insurance adjuster.

In another aspect, the descriptive data comprises for at least one of the claimed items an item name, a brand, a model number, a serial number, a replacement cost, and an age.

In another aspect, at least one entry of the descriptive data is unknown and a placeholder is stored.

In another aspect, the at least one photograph and at least one entry of the descriptive data are sent at a same time from a single device.

In another aspect, the at least one photograph and at least one entry of the descriptive data are sent at different times from multiple devices.

In another aspect, the method comprises uploading one or more additional photographs that correspond with the claimed item.

In another aspect, the method comprises creating a room list that comprises multiple ones of the claimed items and corresponding descriptive data for each of the multiple claimed items.

In another aspect, one of the photographs corresponds with the claimed items and one or more additional claimed items.

One aspect is directed to a server for capturing a contents list for an insurance company. The server comprises processing circuitry, and memory containing instructions executable by the processing circuitry. The server is operative to: receive data to generate an account for the claims application and/or website; receive a room list that comprises a plurality of claimed items in the room, at least one photograph of each of the claimed items, and a description of each of the claimed items; validate the descriptive data and the at least one photograph for the claimed item; and transmit the validated descriptive data and the validated at least one photograph to the independent insurance adjuster.

In another aspect, the server is operative to transmit the validated descriptive data and the validated at least one photograph to the independent insurance adjuster prior to receiving a claim corresponding to one of the claimed items.

In another aspect, the server is further operative to send a link from an independent adjuster to a claims application and/or website.

One aspect is directed to a server for providing claims data to an insurance company. The server comprises processing circuitry, and memory containing instructions executable by the processing circuitry. The server is operative to: receive a claims request for a claim from an insured claimant; transmit the claims request to an independent adjuster; receive acknowledgement that claimed contents in the claims request are covered by an insurance policy; receive an account generation request from the independent adjuster for the insured claimant; receive a contents list from the insured claimant, the contents list comprising at least one photograph and descriptive data with each of the at least one photograph corresponding to at least a portion of the descriptive data; transmit the contents list to the independent adjuster; import the contents list data to the estimation software application; receive a formatted claim from the estimation software application; and transmit the formatted claim for processing by the insurance company.

In another aspect, the server is further operative to transmit a link to an insured claimant to generate a claimant account after receiving the account generation request.

In another aspect, the server is further operative to store the contents list for the insured claimant in the memory.

In another aspect, the server is further operative to receive a request to import data from the contents list to an estimation software application.

### BRIEF DESCRIPTION OF THE DRAWINGS

FIG. 1 is a diagram of the system for preparing and submitting claims with aspects of the present disclosure.

FIG. 2 is an exemplary system in which various aspects of the disclosure can be implemented.

FIG. 3A is a flow chart process of preparing and submitting claims with aspects of the present disclosure.

FIG. 3B is a flow chart process of preparing and submitting claims with aspects of the present disclosure.

FIG. 4A is a flow chart process of preparing and submitting claims with aspects of the present disclosure.

FIG. 4B is a flow chart process of preparing and submitting claims with aspects of the present disclosure.

FIG. 5 is an exemplary home screen for a website of the insured's account.

FIG. 6 is an exemplary dialog box for adding a room to a claims list.

FIG. 7 is an exemplary contents list screen for a claims list with delineated rooms.

FIG. 8 is an exemplary page of a living room folder with no claimed items added.

FIG. 9 is an exemplary dialog box for adding a single photograph with descriptive data.

FIG. 10 is an exemplary dialog box showing multiple options for uploading photographs.

FIG. 11 is an exemplary page of a room with multiple photographs without associated descriptive data.

FIG. 12 is an exemplary dialog box for adding a group of photographs with descriptive data.

FIG. 13 is an exemplary room page for grouping photographs.

FIG. 14 is an exemplary page showing a group of photographs.

FIG. 15 is an exemplary page showing an embodiment for editing descriptive data associated with a photograph.

FIG. 16 is an exemplary dialog box showing an embodiment where each claimed item has a unique name.

FIG. 17 is an exemplary page showing a GUI where grouped photos can be rearranged within the page.

FIG. 18 is an exemplary page showing multiple claimed items in the same photograph.

FIG. 19 is an exemplary page showing the photograph in FIG. 18 with only one of the items in the photograph listed.

FIG. 20 is an exemplary dialogue box for adding descriptive data for another item in the photograph in FIG. 17.

FIG. 21 is an exemplary page showing the photograph in FIG. 17 with multiple items in the photograph listed.

FIG. 22 is an exemplary home screen for a website showing the adjuster's account.

### DETAILED DESCRIPTION

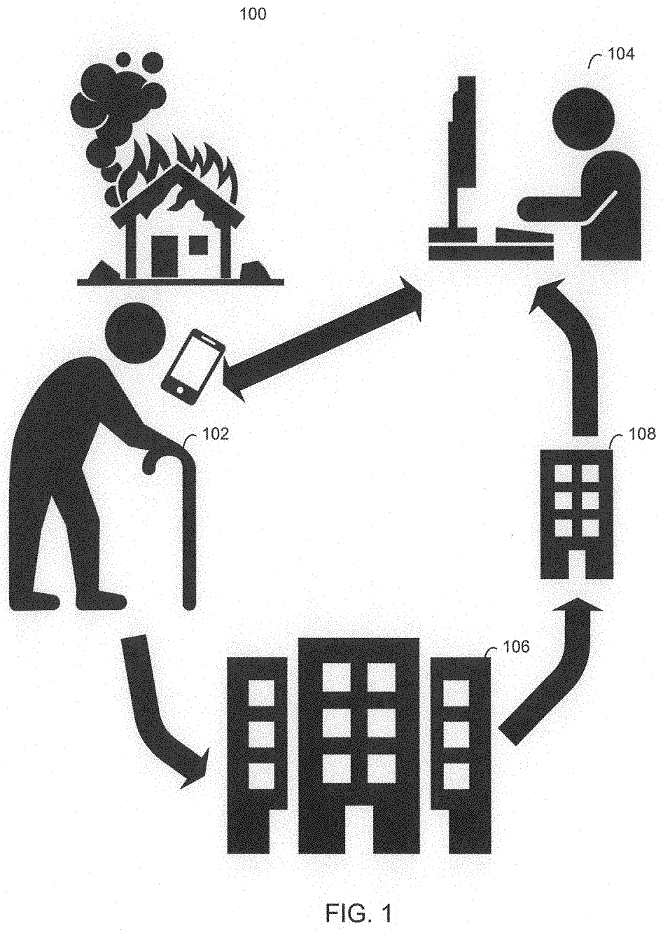

FIG. 1 is a diagram of an exemplary system for preparing and submitting claims with aspects of the present disclosure. In FIG. 1, the system 100 shows an insured claimant 102 who has incurred damage to his insured property. To process a claim for the damage, an independent adjuster 104 reviews his claim in order for the insurance company 106 to compensate the insured claimant 102 for his losses. The system 100 provides for an insured claimant 102 who has experienced an insurance loss (such as a fire as illustrated in FIG. 1) to submit an insurance claim to an insurance company 106. The system 100 can include using an intermediate adjusting firm 108 and an intermediate independent adjuster 104.

In some embodiments, the insured claimant 102 uses their device 110 to initiate the claim with the insurance company 106. In response, the insurance company 106 sends a request to the adjusting firm 108, who assigns the claim to the independent adjuster 104. The insured claimant 102 can initiate a claim on his device 110. The independent adjuster 104, in turn, sends a link to an application and/or website to the insured claimant 102.

In some embodiments, the insured claimant 102 can create an account based on the transmitted link and create a contents list of all claimed items in the claim. The insured claimant 102 then transmits the contents list to the independent adjuster 104, who reviews the contents list (on an adjuster device 114). The review can include the independent adjuster 104 accessing a website and/or application software to review and edit the contents list. The independent adjuster 104 exports the reviewed contents list to an estimation software application that creates a formatted claim meeting the requirements for the adjusting firm 108 and/or the insurance company 106.

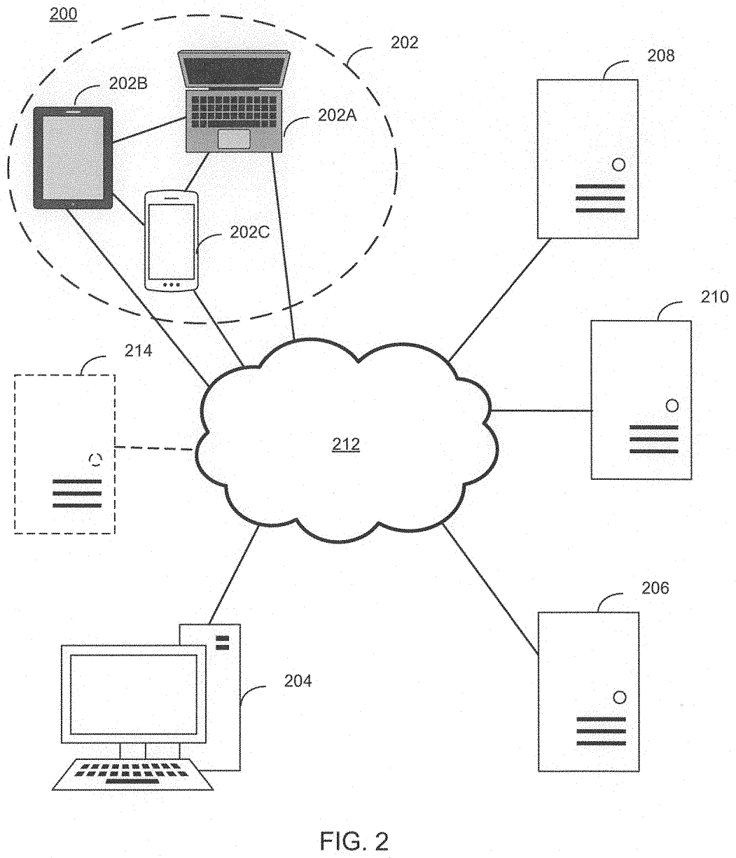

FIG. 2 is an exemplary system 200 in which various aspects of the disclosure can be implemented. The system 200 can include one or more claimant devices 202, an independent adjuster device 204, a claim preparation software device 206, an estimation software device 208, and an insurance company device 210 all connected through a network 212. The claimant devices 202 can belong to one or more claimants 102. The claimant devices 202 can include a laptop 202A, a tablet 202B, and a mobile phone 202C. Other computing devices may be used.

The adjuster device 204 is shown as a desktop, but can be a laptop, a tablet, a mobile phone, or other computing devices. In some embodiments, the system 200 may also include an intermediate adjusting device 214. All devices can be one or more computing devices, such as a server, a desktop, a laptop, a tablet, and a mobile phone.

In some embodiments, the computing devices, such as servers, laptops, desktops, tablets, and mobile phones as shown in FIG. 2 can be multiple servers, laptops, desktops, tablets, and mobile phones used in tandem to perform one action.

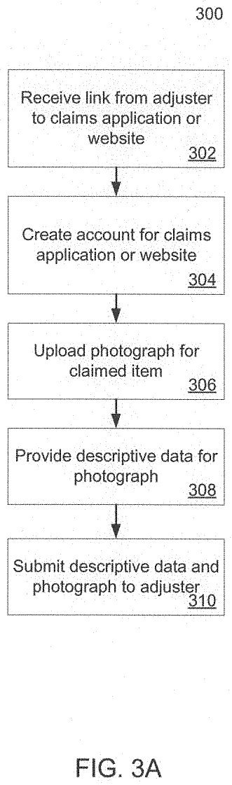

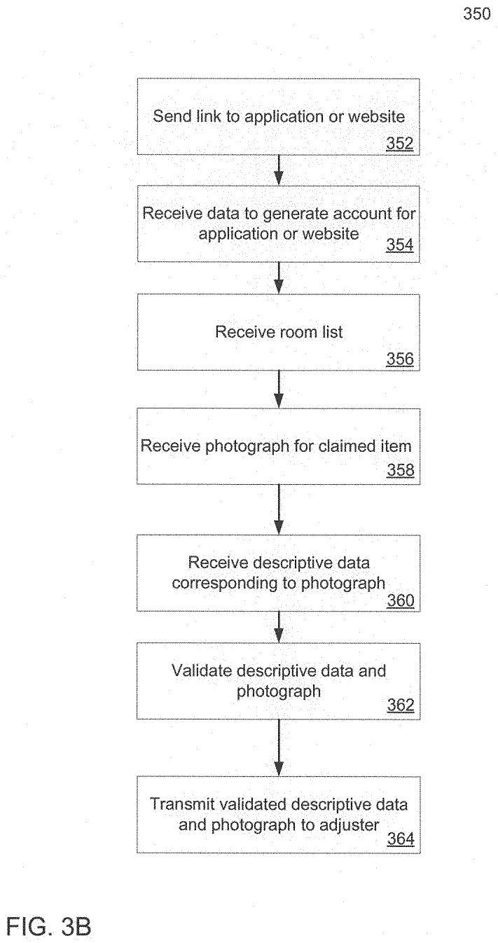

FIG. 3A illustrates a flow chart process 300 of preparing and submitting claims from a consumer side. A link is received from the independent adjuster device 204 to the claim preparation software device 206 (block 302). An account is created for the claim preparation software device 206 (block 304). The claimant device 202 uploads at least one photograph for at least one claimed item (block 306), as well as providing descriptive data corresponding to the at least one photograph (block 308). Once the information in the claim is complete, the claim preparation software device 206 submits the information to the independent insurance adjuster device 204 (block 310).

In some embodiments, the descriptive data can include an item name, a brand, a model number, a serial number, a quantity, a replacement cost, and/or an age of the at least one claimed item. Some embodiments can also include requiring at least one entry of the descriptive data and receiving an error message when the at least one entry of the descriptive data is not provided. In some embodiments, at least one entry of the descriptive data can be unknown and a placeholder character string can be provided.

In some embodiments, the at least at least one photograph and at least one entry of the descriptive data can be received from a single device. In some embodiments, the at least one photograph and at least one entry of the descriptive data can be received from multiple devices. In some embodiments, the estimation software application automatically resizes photographs to ensure they are compatible with the system requirements.

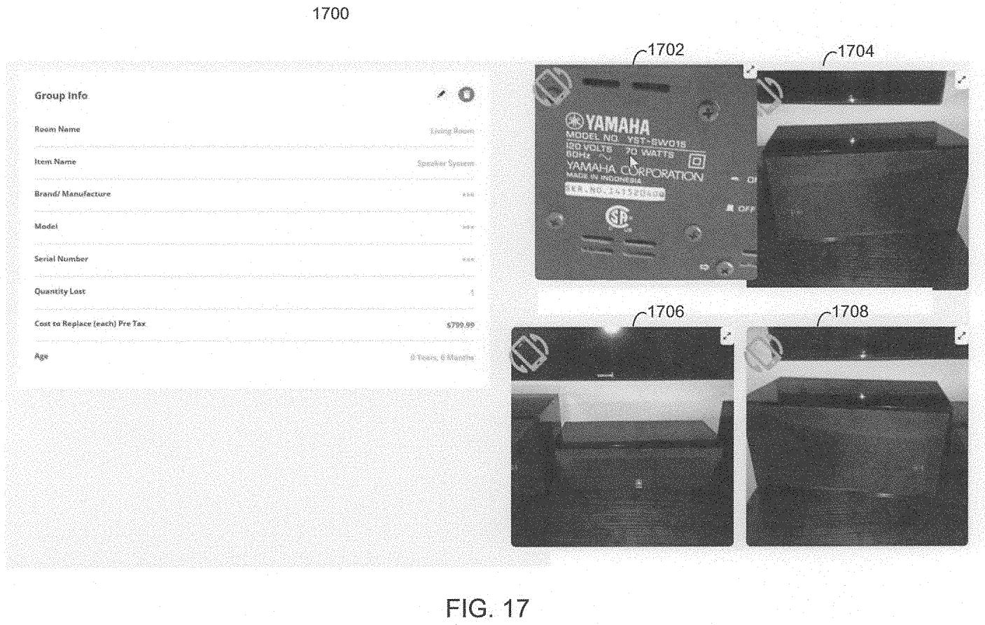

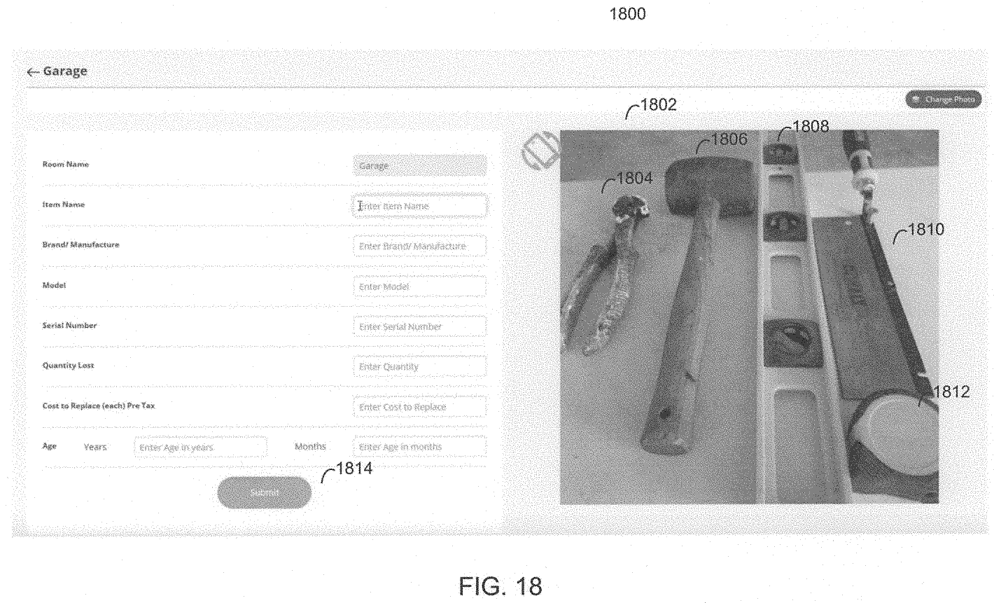

In some embodiments, more than one photograph can correspond with the same descriptive data, as described below in FIG. 17. In some embodiments, at least one of the photographs corresponds with more than one of the claimed items, as described below in FIGS. 18-21. Some embodiments can also include creating a room list. For example, each of the at least one photographs can correspond with one room in the room list.

In some embodiments, once the photographs and descriptive data are complete, an image search can be used to find replacement for “like, kind, and quantity” of the claimed items, which can also be submitted to the independent adjuster device 204. For example, a Google® image search can be used to search for items on Amazon®, Walmart®, Target®, and the like to provide a list with places to purchase replacement items.

In some embodiments, the insured claimant device 202 can have geolocation information or other metadata on each photograph that can be uploaded along with the photograph. In some embodiments, this can allow the independent adjuster 104 to determine if the item is not in the same location as the rest of the damaged property. This can be useful in various ways, for example, to prevent potential insurance fraud.

FIG. 3B is a flow chart process 350 of preparing and submitting claims with aspects of the present disclosure. The process includes sending a link from the independent adjuster device 204 to the claim preparation software device 206 (block 352). The claim preparation software device 206 receives data to generate an account as part of the website and/or app (block 354). The claim preparation software device 206 receives a room list (block 356) and at least one photograph for at least one claimed item (block 358). The claim preparation software device 206 also receives descriptive data corresponding to the at least one photograph, wherein each of the at least one photographs corresponds with one room in the room list (block 360). The claim preparation software device 206 validates the descriptive data and the at least one photograph to ensure required data is received (block 362). The claim preparation software device 206 transmits the validated descriptive data and the validated at least one photograph to the independent insurance adjuster device 204 (block 364).

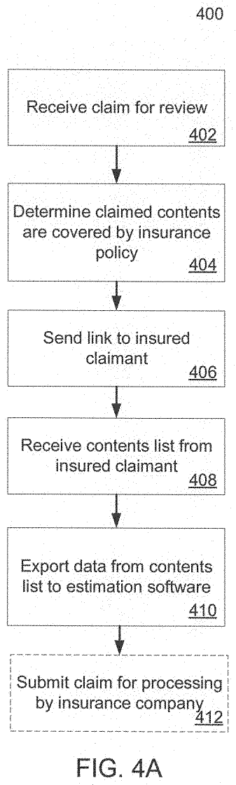

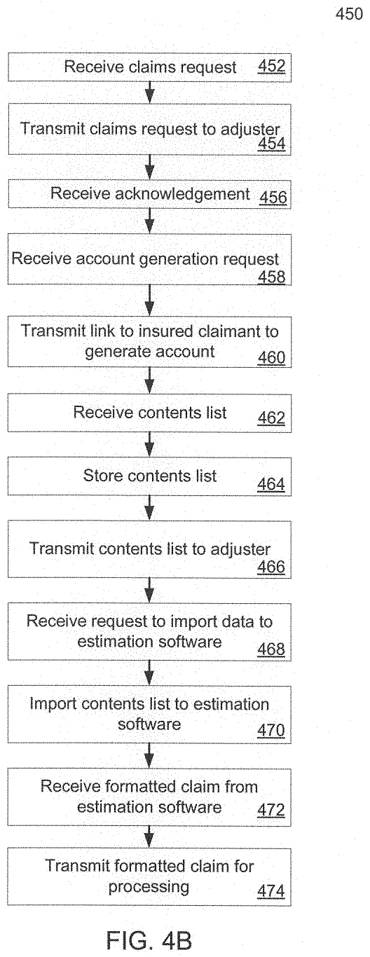

FIG. 4A is a flow chart process 400 of preparing and submitting claims with aspects of the present disclosure. The claim preparation software device 206 receives a claim for review (block 402). The claim preparation software device 206 determines whether the claimed contents in the claim are covered by an insurance policy (block 404). When it is determined that the claimed contents are covered by the insurance policy, the claim preparation software device 206 sends a link to an insured claimant (block 406). The claim preparation software device 206 receives a contents list from the insured claimant (block 408). The claim preparation software device 206 imports data from the contents list to an estimation software application (block 410). In some embodiments, the claim preparation software device 206 can submit the claim for processing by the insurance company device 210 for processing (optional block 412).

In some embodiments, the independent adjuster 104 can edit the contents list. In some embodiments, the claim preparation software device 206 can store claim data from the contents list. For example, the claim data can include at least one of photograph and corresponding descriptive data for a claimed item. In some embodiments, the claim preparation software device 206 can receive a request from the insurance company device 210 for data associated with at least one item of the contents list and sending a message to the insured claimant device 202 for the requested data with a link to the at least one item. For example, the link to the at least one item can be to a page in an application and/or website accessible by the insured claimant device 202 that collected the contents list, wherein the page corresponds to the at least one item.

In some embodiments, receiving the contents list from the insured claimant can include receiving a notification that the contents list is available. In some embodiments, the estimation software is one of a plurality of estimation software packages to which the data from the contents list is configured to be imported. For example, the estimation software can be Simsol® or Xactware®.

FIG. 4B is a flow chart process 450 of preparing and submitting claims with aspects of the present disclosure. The claim preparation software device 206 receives a claims request for a claim from an insured claimant (block 452). The claim preparation software device 206 then transmits the claims request to an independent adjuster device 204 (block 454). The claim preparation software device 206 receives an acknowledgement that claimed contents in the claims request are covered by an insurance policy (block 456). The claim preparation software device 206 receives an account generation request from the independent adjuster device 204 for the insured claimant (block 458).

The claim preparation software device 206 transmits a link to at least one insured claimant device 202 to generate a claimant account (block 460). The claim preparation software device 206 receives a contents list from the insured claimant device 202, the contents list including at least one photograph and descriptive data, each of the at least one photograph corresponding to at least a portion of the descriptive data (block 462). The claim preparation software device 206 stores the contents list for the insured claimant in the memory and transmits the contents list to the independent adjuster device 204 (block 466). The claim preparation software device 206 receives a request to import data from the contents list to an estimation software device 208 (block 468).

The claim preparation software device 206 exports the contents list data to the estimation software application (block 470). The claim preparation software device 206 receives a formatted claim from the estimation software device 208 (block 472) and transmits the formatted claim for processing by the insurance company device 210 (block 474).

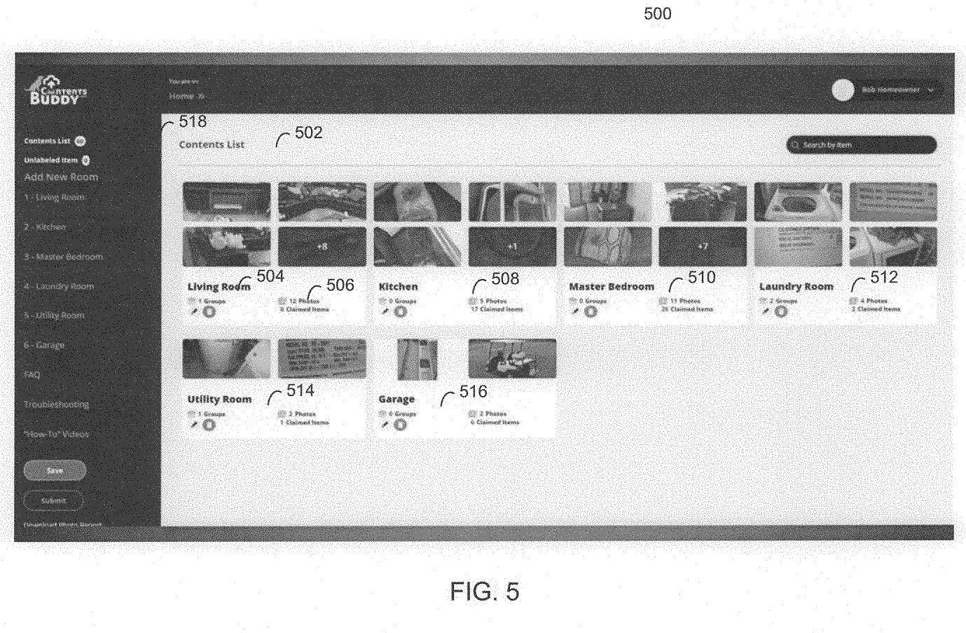

FIG. 5 is an exemplary home screen 500 for a website of the account of the insured claimant 102 with descriptive data and photographs already input. The home screen 500 can include a Contents List page 502. In some embodiments, the Contents List page 502 can include all rooms that have been added with thumbnails of photographs associated with those rooms. In FIG. 5, the Living Room block 504 shows a description bar 506 that the insured claimant 102 has uploaded twelve photos associated with eight items and one group. The Living Room block 504 has thumbnails of three photographs in the block 504. As shown, the Contents List also has a Kitchen block 508, a Master Bedroom block 510, a Laundry Room block 512, a Utility Room block 514, and a Garage block 516. On the home screen 500, a sidebar 518 allows the insured claimant 102 to navigate to the Contents List page 502, edit unlabeled items (discussed further below), add a new room (discussed further below), navigate to a room corresponding to the room blocks in the Contents List page 502, and find help. The sidebar 518 also includes “save” and “submit” options.

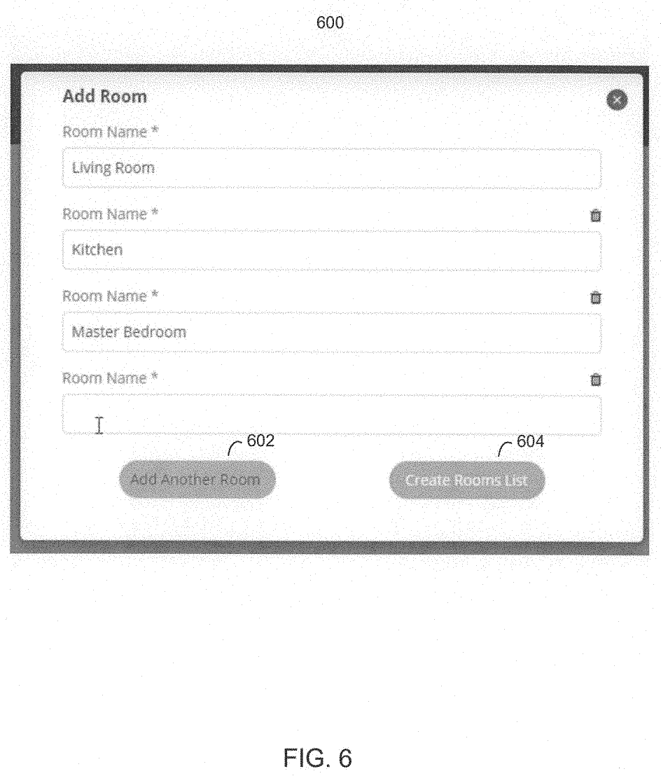

FIG. 6 is an exemplary dialog box 600 for adding a room to a claims list. In one embodiment, the insured claimant 102 can select “Add New Room” from the sidebar 418 in FIG. 4 to add a room. The Add Room dialog box 600 appears with data needed to create a room in the contents list. In some embodiments, the dialog box 600 can allow a user to add multiple rooms at the same time. For example, the dialog box 600 can include an “Add Another Room” button 602 that inserts a line in the dialog box 600. When the insured claimant 102 is finished adding rooms and naming rooms in the dialog box 600, he can click the “Create Rooms List” button 604. In one example, each room name is unique. In one example, the system can provide differentiating numbers or letters next to the room names if duplicates are created. In one example, a warning can appear if a room with the same name as the insured claimant 102 is trying to create already exists. In some embodiments, the insured claimant 102 can add rooms after an initial room list has already been generated.

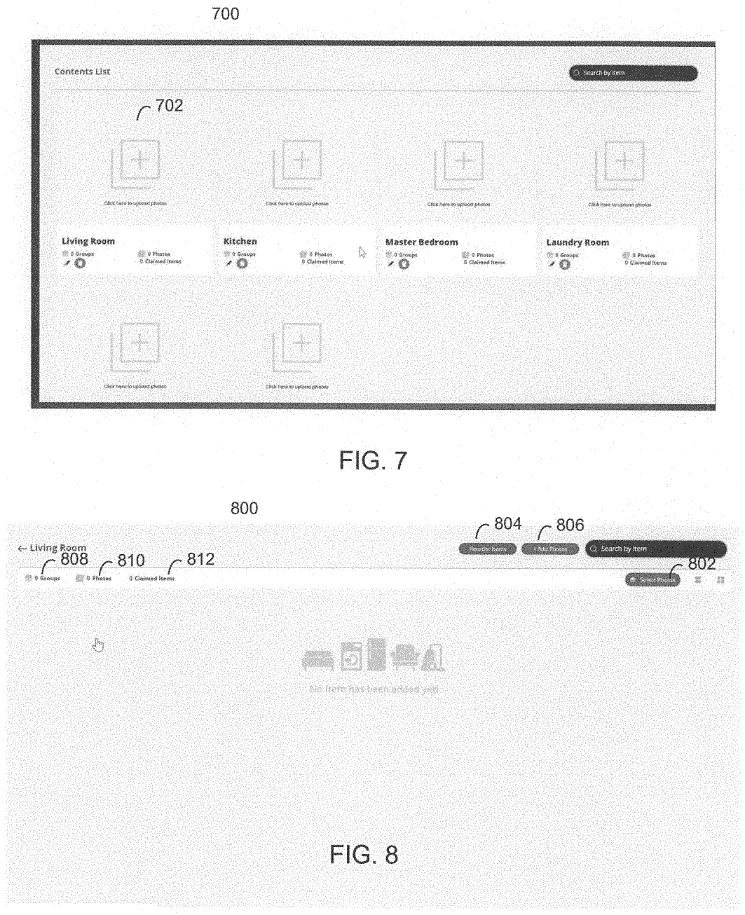

FIG. 7 is an exemplary contents list screen 700 for a claims list with delineated rooms. In FIG. 7, no descriptive data or photographs of claimed items have been uploaded and associated with the current rooms in the Contents List. In some embodiments, to add photographs to a room, the insured claimant 102 can click on the “click here to upload photos” icon 702. In some embodiments, the sidebar 518 of FIG. 5 can be part of the webpage, and the insured claimant 102 can click on the room name on the sidebar 518. Both embodiments navigate the insured claimant 102 to the exemplary page 800 in FIG. 8.

FIG. 8 is an exemplary page 800 of a living room folder with no claimed items added. As shown, the Living Room page 800 can include a “select photos” button 802, a “reorder items” button 804, an “add photos” button 806, a “groups” button 808, a “photos” button 810″, and a “claimed items” button 812. In this embodiment, the Living Room page 800 does not have any data input, and so the groups, photos, and claimed items buttons (808, 810, 812) all show “0” for the number of items in each category.

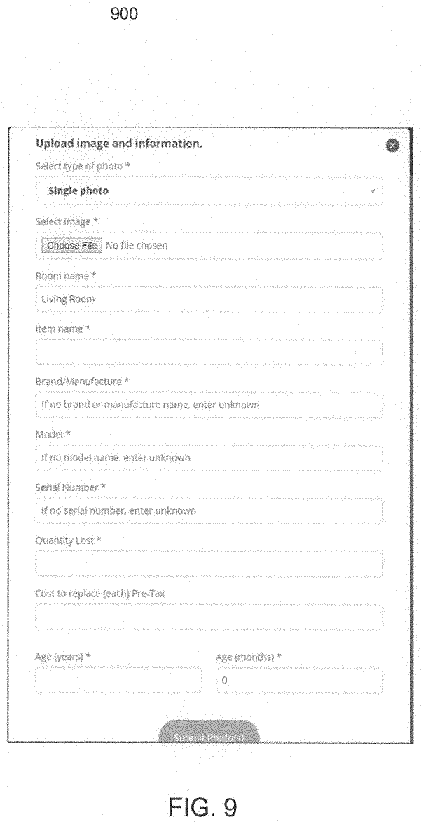

FIG. 9 is an exemplary dialog box 900 for adding a single photo with data. In some embodiments, if the insured claimant 102 clicks the “add photos” button 706 of FIG. 7, a dialog box 900 titled “upload image and information” can appear. The dialog box 900 can include forms for inserting descriptive data such as the room name, the item name, the brand or manufacture, the model name or number, the serial number, the quantity claimed, the cost to replace the claimed item, and the age. As shown in FIG. 9, the age of the item can be input in years and months. In some embodiments, the insured claimant 102 can receive an error message if designated descriptive data is not properly provided. In some embodiments, the insured claimant 102 can receive an error message if the room name does not already exist.

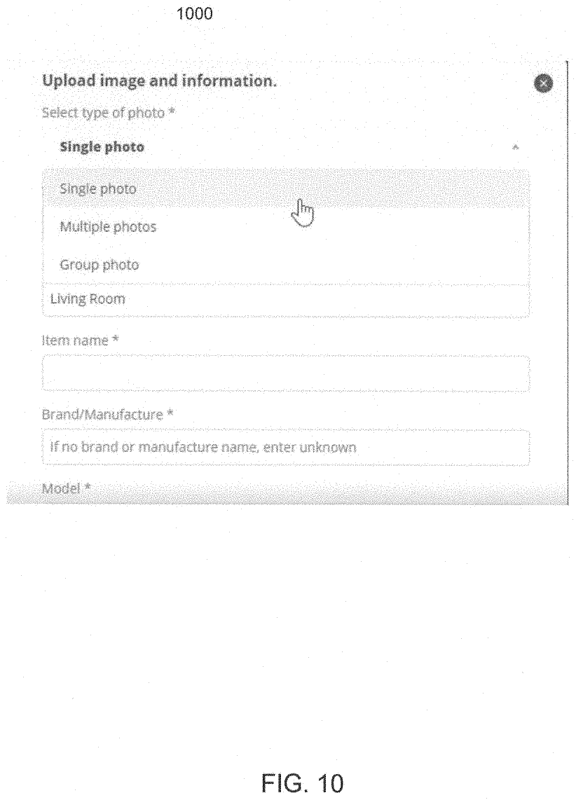

The dialog box 900 is shown with a drop down for selecting the type of photo. FIG. 10 is an exemplary dialog box 1000 showing multiple options for uploading photos. As shown, FIG. 10 includes three types of photograph options: single photo, multiple photos, and group photo. In some embodiments, the single photo option can allow the insured claimant 102 to add one picture at a time and input descriptive data for that photograph individually. In some embodiments, the multiple photo option can allow the insured claimant 102 to add multiple photographs at one time without adding the descriptive data for each photograph at that time. In some embodiments, the group photo option can allow the insured claimant 102 to add multiple photographs of the same item so that all photographs are associated with the same descriptive data.

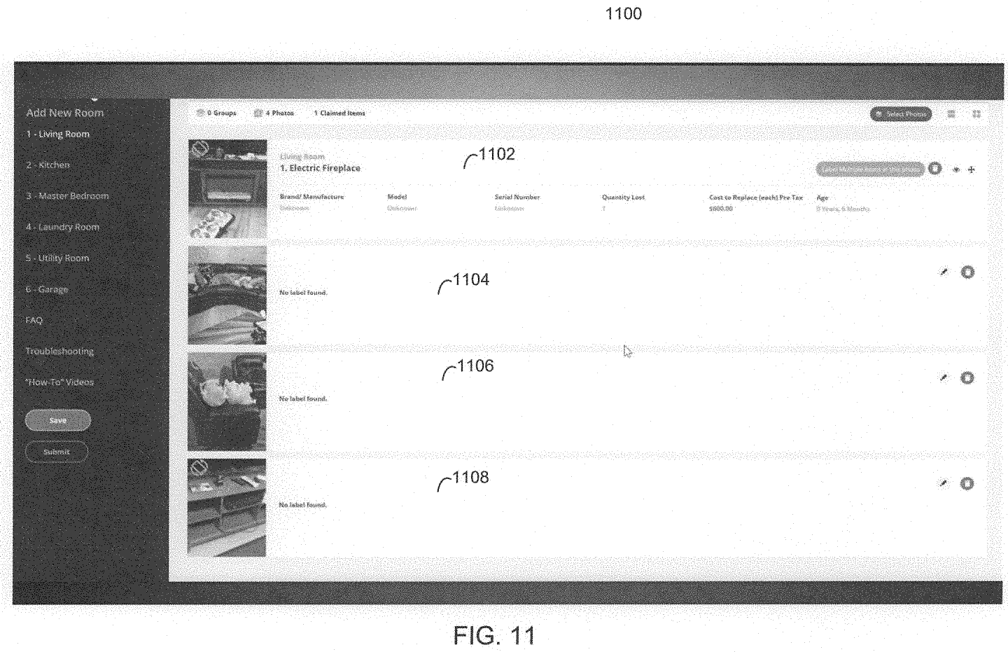

FIG. 11 is an exemplary page 1100 of a room with multiple photographs without associated data. In FIG. 11, the electric fireplace photograph entry 1102 has associated descriptive data. Photograph entries 1104, 1106, and 1108 do not have associated descriptive data. The insured claimant 102 can select an unassociated photograph, such as photograph 1104, and provide the descriptive data for that photograph. In some embodiments, the insured claimant 102 can add more photographs before entering descriptive data for any photographs.

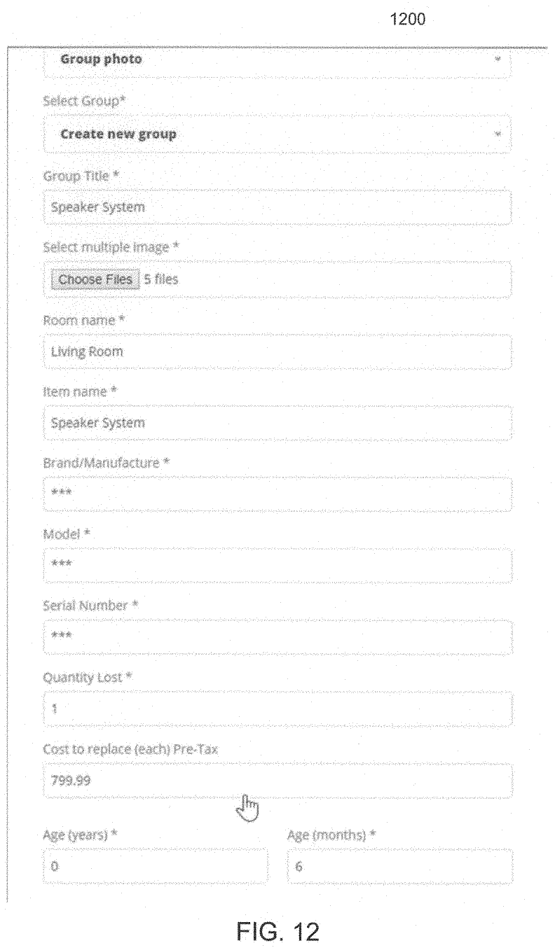

FIG. 12 is an exemplary dialog box 1200 for adding a group of photographs with descriptive data. The dialog box 1200 can allow the insured claimant 102 to add photographs to a preexisting group. The dialog box 1200 can allow the insured claimant 102 to create a new group with the photographs selected to upload. In some embodiments, the insured claimant 102 can add photographs of different angles of the same item. In some embodiments, the insured claimant 102 can add photographs of the model, serial number, and other identifying markings on a claimed item into a group for that item. The dialog box 1200 can include forms for inserting descriptive data such as the room name, the item name, the brand or manufacture, the model name or number, the serial number, the quantity claimed, the cost to replace the claimed item, and the age. As shown in FIG. 12, the age of the item can be input in years and months. In some embodiments, the insured claimant 102 can receive an error message if designated descriptive data is not properly provided. In some embodiments, the insured claimant 102 can receive an error message if the room name does not already exist.

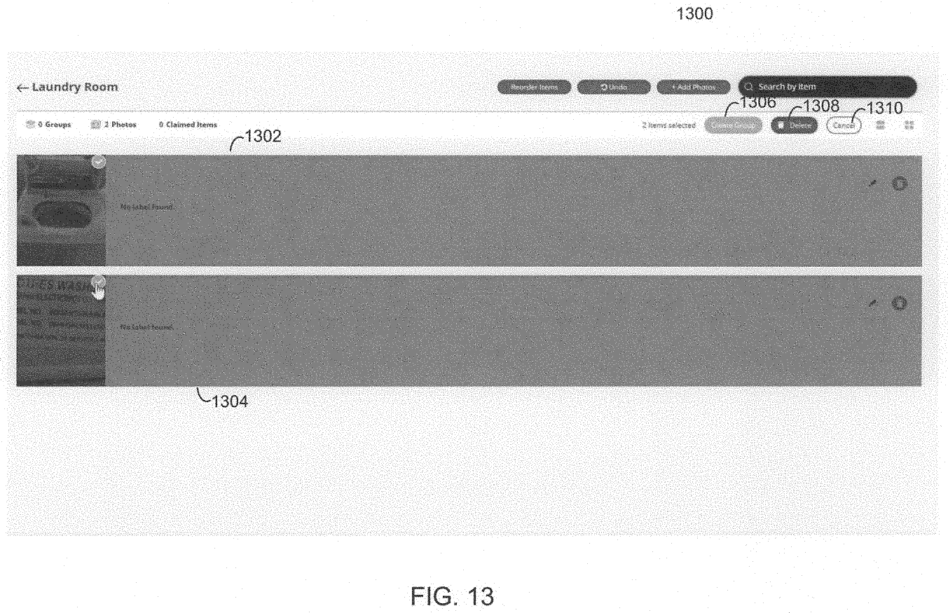

FIG. 13 is an exemplary room page 1300 to show another embodiment for grouping photographs. In some embodiments, the room page 1300 can be associated with a Laundry Room block on the home page 400. The Laundry Room page 1300 as shown in FIG. 13 has two photographs with no descriptive data. The top photograph 1302 shows an open washing machine and the bottom photograph 1304 shows a model and serial number for the same washing machine. In FIG. 13, photographs 1302 and 1304 are selected. The buttons shown in the upper right corner of the page 1300 allow for the insured claimant 102 to create a group with selected photographs using the “create group” button 1306, delete selected photographs using the “delete button” 1308, or cancel the selection of the photographs with the cancel button 1310. In some embodiments, if the insured claimant 102 selects the “create group” button 1306, the dialog box 1100 of FIG. 11 can appear to allow the insured claimant 102 to input descriptive data for the group.

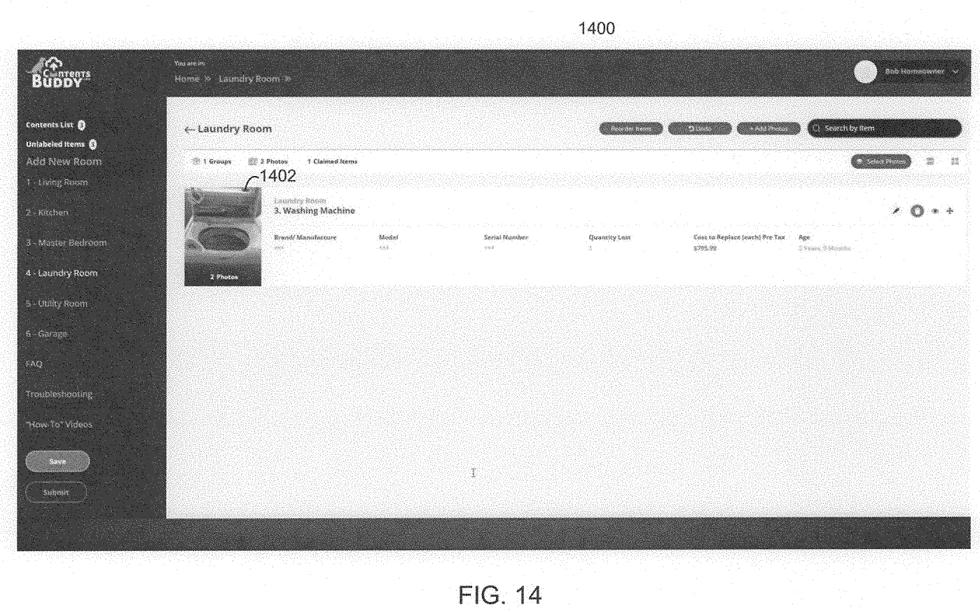

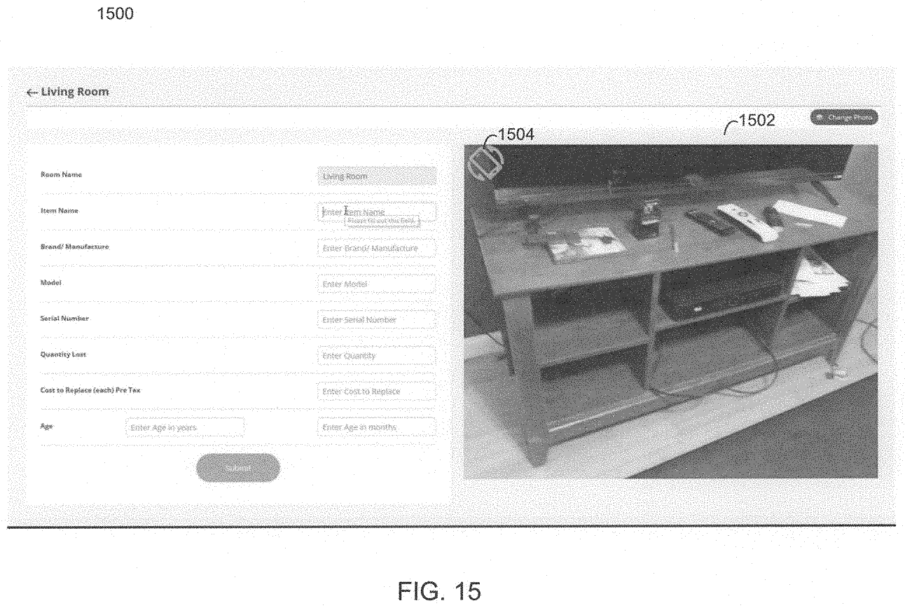

FIG. 14 is an exemplary page 1400 showing a group 1402 of photographs created from FIG. 13 if an insured claimant 102 clicked the “create group” button 1306 and then input descriptive data in the dialog box 1200 of FIG. 12. With different embodiments allowed to create and modify a group, the insured claimant 102 can add descriptive data and photographs using different platforms until the insured claimant 102 is ready to submit the claims to the independent adjuster.

FIG. 15 is an exemplary page 1500 showing an embodiment for editing descriptive data associated with a photograph 1502. In some embodiments, the insured claimant 102 can navigate to this page using the sidebar 518 of FIG. 5 and selecting “Unlabeled Items”. In some embodiments, a grid or list of photographs without associated descriptive information can be displayed. In some embodiments, the insured claimant 102 can then select a photograph to edit and arrive on a page like page 1500 of FIG. 15. On this page 1500, the insured claimant 102 can edit the photograph 1502 using an icon 1504. In some embodiments, the photograph 1502 can be flipped horizontally or vertically, rotated, changed with regard to brightness and/or contrast, and other known manipulations to such files. Similar to the dialog boxes of FIGS. 9 and 12, the insured claimant 102 can input the descriptive data for a photograph and change which room the item is associated with. The forms for inserting descriptive data can include the room name, the item name, the brand or manufacture, the model name or number, the serial number, the quantity claimed, the cost to replace the claimed item, and the age. As shown in FIG. 15, the age of the item can be input in years and months. In some embodiments, the insured claimant 102 can receive an error message if designated descriptive data is not properly provided. In some embodiments, the insured claimant 102 can receive an error message if the room name does not already exist.

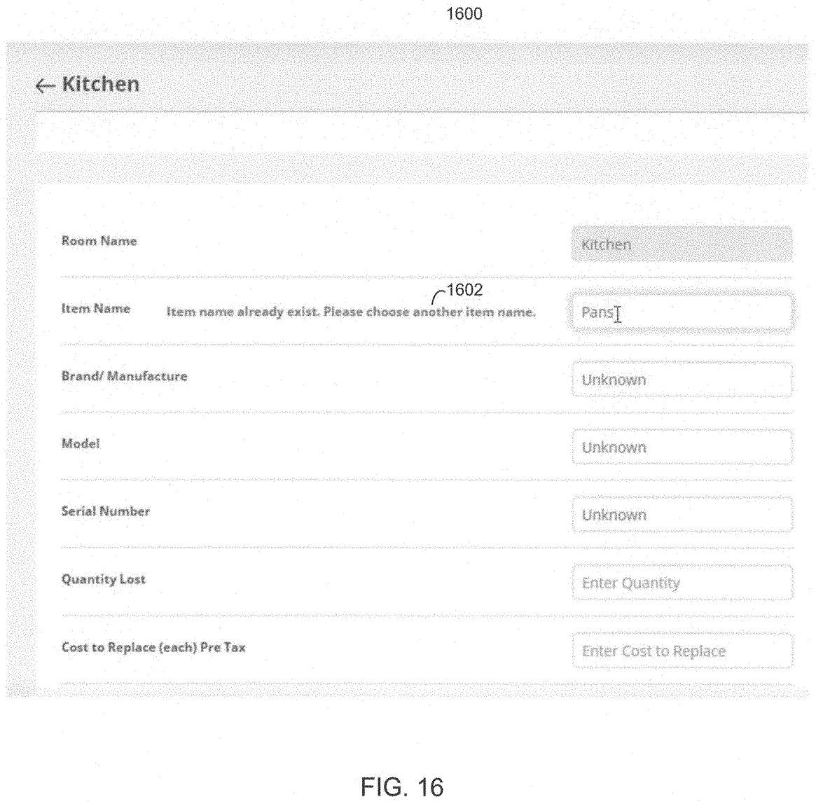

FIG. 16 is an exemplary dialog box 1600 showing an embodiment where each claimed item has a unique name. In some embodiments, each claimed item must have its own unique name in a claim or in a room that is being claimed. For example, if the insured claimant 102 uses the same name in the same room, he may see an error message 1602 that there is already an item named “pans”. In this example, the insured claimant 102 must input a name that is not used for any other item in the room before he is able to submit the descriptive data for the item.

FIG. 17 is an exemplary group page 1700 showing where grouped photos can be rearranged within the page. As shown, FIG. 17 has four photographs, 1702-1708. Photograph 1702 is shown as having identification data that can be used as descriptive data for the item that the group shows. The insured claimant 102 may want to move photograph 1702 to a primary position within the group for various reasons, such as ease of descriptive data entry or for easy identification when looking at multiple items in a room. As shown, the insured claimant 102 can move photograph 1702 to a primary location in the grid of photographs by dragging and dropping photograph 1702. Other known methods of graphical manipulation can also be used. In some embodiments, the photographs 1702-1708 can be individually edited or edited as a group, such as flipped horizontally or vertically, rotated, changed with regard to brightness and/or contrast, and other known manipulations to such files. In some embodiments, the insured claimant 102 can delete and add photographs on the page 1700.

Similar to the dialog boxes of FIGS. 9 and 12, the insured claimant 102 can input the descriptive data for a photograph and change which room the item is associated with. The forms for inserting descriptive data can include the room name, the item name, the brand or manufacture, the model name or number, the serial number, the quantity claimed, the cost to replace the claimed item, and the age. As shown in FIG. 17, the age of the item can be input in years and months. In some embodiments, the insured claimant 102 can receive an error message if designated descriptive data is not properly provided. In some embodiments, the insured claimant 102 can receive an error message if the room name does not already exist. In some embodiments, the insured claimant 102 can also edit any previously saved descriptive data.

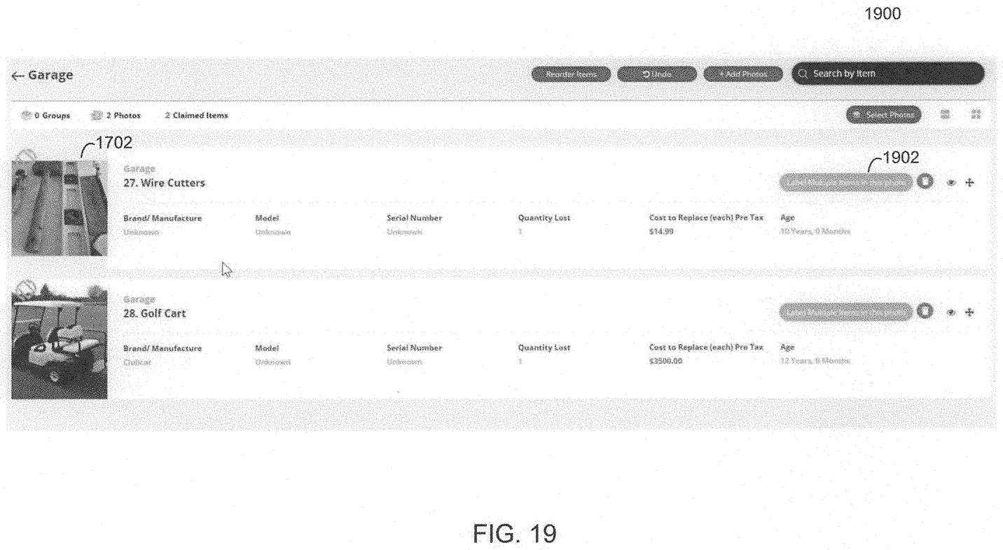

FIGS. 18-21 are exemplary pages showing how to use one photograph to claim multiple items. In FIG. 18, a single photograph 1802 shows multiple items: wire cutters 1804, a rubber mallet 1806, a level 1808, a saw 1810, and a tape measure 1812. Similar to page 1500 of FIG. 15, forms for entering descriptive data are on the left. In some embodiments, the insured claimant 102 can enter data for one item, for example, the wire cutters 1804 and submit the data when finished. In some embodiments, after the submit button 1814 is selected, a listing of items in a room can be navigated to. FIG. 19 shows such an exemplary page 1900.

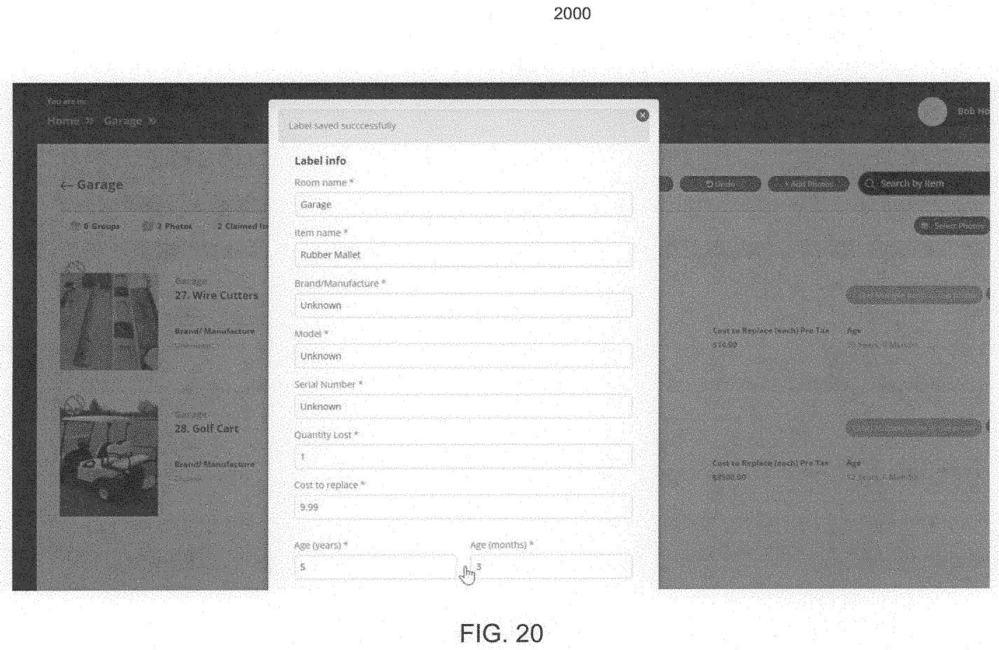

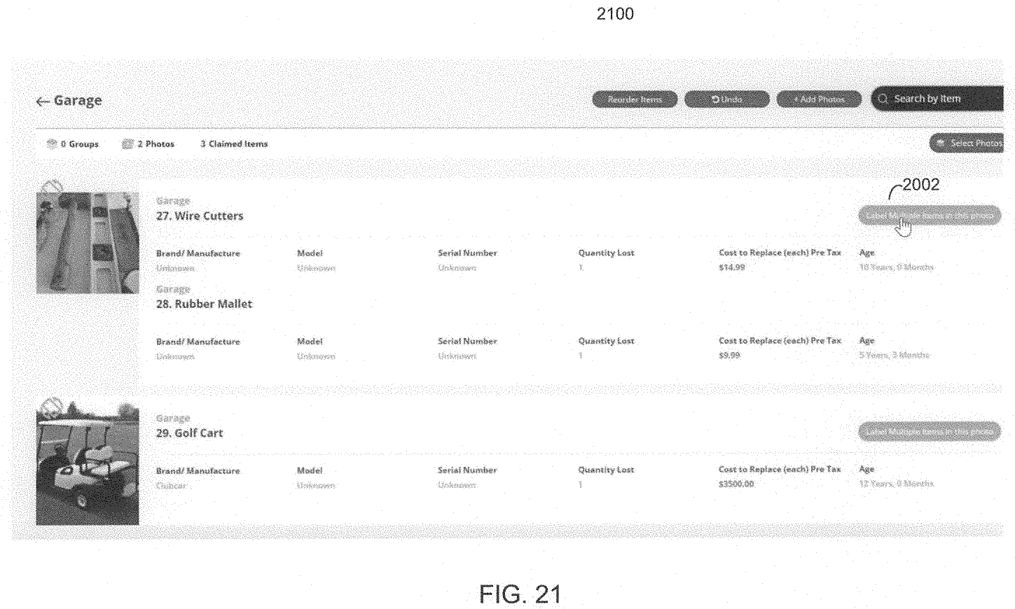

FIG. 19 shows the photograph 1802 in FIG. 18 with only the wire cutters 1804 in the photograph 1802 listed. To the right of the photograph 1802 is a “Label Multiple Items in this photo” button 1902. If the insured claimant 102 selects this button 1902, a dialog box may appear. FIG. 19 shows such an exemplary dialogue box 1900 for adding descriptive data for another item in the photograph in FIG. 17. As shown in FIG. 20, the insured claimant 102 has entered data for the rubber mallet 1806. Once the insured claimant 102 has provided descriptive data for submission, the dialog box 2000 may close, and an updated version of page 1900 can be displayed. For example, the page 1900 may look like the page 2100 shown in FIG. 21 where both the wire cutters 1804 and the rubber mallet 1806 are displayed. In some embodiments, the insured claimant 102 can continue to select the “Label Multiple Items” button 2102 until all items in the photograph 1702 that the insured claimant 102 wishes to claim are itemized.

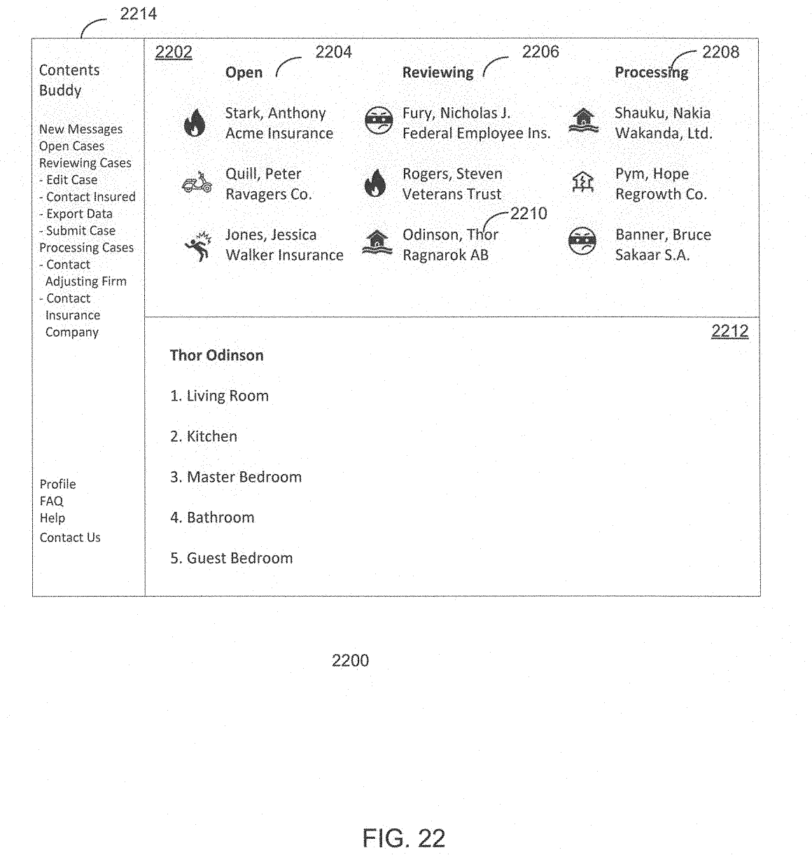

FIG. 22 is an exemplary home screen 2200 for a website showing the account of the independent adjuster 104. The home page of the independent adjuster 104 shows a list 2202 of insured claimants whose cases are assigned to the independent adjuster 104. As shown in FIG. 22, the list 2202 can include a column for open cases 2204, a column for cases to be reviewed 2206, and a column for cases that the independent adjuster 104 has sent to the adjusting firm for processing 2208. One case 2210 in the reviewing column 2206 can be selected to appear with more detail in the lower pane 2212. In some embodiments, photographs can show along with descriptive data. In some embodiments, potential errors with the insured claimant's submitted claim can be flagged.

The home screen 2200 can also include a side bar 2214 that can provide the independent adjuster 104 with multiple screen navigation options, such as “new messages”, “open cases”, “reviewing cases”, “processing cases”, “profile”, “FAQ”, “Help”, and “Contact Us”. The “reviewing cases” option can provide a submenu for editing cases, contacting the insured claimant 102, exporting data from the system for an estimation software application, such as Simsol® or Xactware®, and submitting a case directly to the adjusting firm 108 or insurance company 106. The “processing cases” option can provide a submenu for contacting the insurance company 106 and the adjusting firm 108.

FIG. 22 also shows the name of the insured claimant 102, the insurance company 106 of the insured claimant 102, and an icon to signify the kind of policy coverage the insured claimant 102 is stating should be used. In FIG. 22, fire, vehicle, liability, theft, flood, and earthquake events have occurred.

The present invention may be carried out in other ways than those specifically set forth herein without departing from essential characteristics of the invention. The present embodiments are to be considered in all respects as illustrative and not restrictive, and all changes coming within the meaning and equivalency range of the appended enumerated embodiments are intended to be embraced therein.

What is claimed is:

1. A method of capturing a contents list for an insurance company, the method comprising:
receiving a link from an independent insurance adjuster to a claims application and/or website;
uploading at least one photograph for at least one claimed item in an account for the claims application and/or website;
providing descriptive data corresponding to the at least one photograph; and
submitting the descriptive data and the at least one photograph to the independent insurance adjuster.

2. The method of claim 1, wherein the descriptive data comprises for at least one of the claimed items:
an item name;
a brand;
a model number;
a serial number;
a replacement cost; and
an age.

3. The method of claim 1, wherein at least one entry of the descriptive data is unknown and a placeholder is stored.

4. The method of claim 1, wherein the at least one photograph and at least one entry of the descriptive data are sent at a same time from a single device.

5. The method of claim 1, wherein the at least one photograph and at least one entry of the descriptive data are sent at different times from multiple devices.

6. The method of claim 1, further comprising uploading one or more additional photographs that correspond with the claimed item.

7. The method of claim 1, further comprising creating a room list that comprises multiple ones of the claimed items and corresponding descriptive data for each of the multiple claimed items.

8. The method of claim 6, wherein one of the photographs corresponds with the claimed items and one or more additional claimed items.

9. A server for capturing a contents list for an insurance company, the server comprising:
processing circuitry;
memory containing instructions executable by the processing circuitry where the server is operative to:
receive data to generate an account for the claims application and/or website;
receive a room list that comprises a plurality of claimed items in the room, at least one photograph of each of the claimed items, and a description of each of the claimed items;
validate the descriptive data and the at least one photograph for the claimed item; and
transmit the validated descriptive data and the validated at least one photograph to the independent insurance adjuster.

10. The server of claim 9, wherein the server is operative to transmit the validated descriptive data and the validated at least one photograph to the independent insurance adjuster prior to receiving a claim corresponding to one of the claimed items.

11. The server of claim 9, wherein the server is further operative to send a link from an independent adjuster to a claims application and/or website.

12. A server for providing claims data to an insurance company, the server comprising:
processing circuitry;
memory containing instructions executable by the processing circuitry where the server is operative to:
receive a claims request for a claim from an insured claimant;
transmit the claims request to an independent adjuster;
receive acknowledgement that claimed contents in the claims request are covered by an insurance policy;
receive an account generation request from the independent adjuster for the insured claimant;
receive a contents list from the insured claimant, the contents list comprising at least one photograph and descriptive data, each of the at least one photograph corresponding to at least a portion of the descriptive data;
transmit the contents list to the independent adjuster;
import the contents list data to the estimation software application;
receive a formatted claim from the estimation software application; and
transmit the formatted claim for processing by the insurance company.

13. The server of claim 12, wherein the server is further operative to transmit a link to an insured claimant to generate a claimant account after receiving the account generation request.

14. The server of claim 12, wherein the server is further operative to store the contents list for the insured claimant in the memory.

15. The server of claim 12, wherein the server is further operative to receive a request to import data from the contents list to an estimation software application.
